(19) United States
(12) Patent Application Publication
(10) Pub. No.: US 2023/0099427 A1
(43) Pub. Date: Mar. 30, 2023

(54) Time Machines

(71) Applicant: Menni Menashe Zinger, Ashkelon (IL)

(72) Inventor: Menni Menashe Zinger, Ashkelon (IL)

(21) Appl. No.: 17/548,511

(22) Filed: Dec. 11, 2021

(30) Foreign Application Priority Data
Apr. 17, 2019 (IL) 266246
Nov. 12, 2020 (IL) 279390
Oct. 7, 2021 (IL) 287097

(51) Int. Cl. H04W 4/021

(52) U.S. Cl. CPC H04W 4/021

(57) ABSTRACT

At this invention I represent a method to travel at time and scenario/s/dimension/s etc. 2

### DESCRIPTION

At this invention I represent a method to travel at time and place scenario/dimension by using intellectual, thinking ability, concentration ability fit for most people and also technological ability that exist few decades. All claims can be beyond time/scenario/dimension and combined.

Theory about astrology and the stars and planets: the stars and planets has magnetic, electromagnetic, electric field influence on climate, that we learn from the phrase at Judaism: “to replace chima/Chime with Csil ”, those are two stars that considered to be changing the climate at earth and this replacement can

cause great flood, “mabool ” like that at Genesis 6 at the holly bible and if the stars and their position can influence earth so they can influence the development of babies before they come to world with the same powers I wrote before. every arrangement of star map on space above earth has different signature of magnetic influence, electromagnetic influence electric filed and every baby get influenced from a different star map, star arrangement above him. From: masehet brachot page 58 b, at the Talmud. And eiov 9,9. at the Holly Bible. chima is also called Pleaded and csil is also called Orion.

Theory about time machines: if the time machines were invented by me and they work so it is a sign that god permit to save people beyond time from wars, accidents, attacks of any kind, illnesses etc. specially if the inventor might be unique from spiritual aspect. Interesting use for the invention here: Using quantum mechanics and inspiration zones and model, mechanics one in order to increase the sunlight and light reflects from moon surface as it promised at the prophesies, 49 times the moon and 343 times the sun by using increasing lances and or getting closer the sun to earth or the moon to earth and/or increasing the sun and or moon by using inspiration of quantum mechanics by using magnetic/electromagnetic/t.v waves/radio waves/electric filed and using increased model of the sun and moon and earth also an option separately or together with changing ratios by doing it on few steps, each planet moon, sun every time in order to make a difference at every operation and transmitting the model to the open air, space as strong as needed by using antennas and magnetic/electromagnetic other methods above also using filters of dangerous radiations and particles.

*It is possible to change frequency after changing scenario if the changes do not last for long time in order to avoid returning to old magnetic balance/electro magnetic balance/electric filed balance etc. probable that it would not be needed.

Maybe it is possible to increase power of inspiration zones by using radiation/s in addition to electro magnetic radiation, it should be tested what kind of radiation is preferred and maybe the passengers will need protecting suits or only certain equipment could pass safely. maybe also negative ions influence on inspiration zones and circulation between negative and positive ions allow the creation of inspiration zones and pass of communication and launches too.

Maybe the combination between the heliosphere and magnetosphere allow life on earth by inspiring the right terms, conditions all over earth from sun and other places on space by inspiring the conditions and it is possible to inspire by using the magnetosphere caricatures. It is possible to inspire earth atmosphere on mars atmosphere or opposite or any planet on any other planet/moon and allow life to exist. 3

Maybe by using strong lasers it is possible to create inspiration zones if they will be aimed to certain room/area and it is possible to increase power of inspiration zones that use magnetic /electro magnetic/other methods at this invention methods and maybe it is possible to use middle way stations in order to have inspiration zones at long range by using strong lasers at middle stations.

Direct current can be used in order to create inspiration zones because of its strong power and not only un direct current. also very important the frequency of magnets can influence a lot and create different inspiration zones and different scenarios/dimensions.

Maybe the first man/Adam was inspiration of god on earth or heaven by using quantum mechanics, spiritually or technologically and the great change at his size from filling all the world into 100 meters was done also by using quantum mechanics and inspiration zones and in order to prevent being two gods, the duplicate was minimized to 100 meters because he suppose as seined and should be punished and fix it self-thousands of years in order to depress him and prevent him from being a god and he should fix everything until he deserve a revelation/geula. other proof for that is that the angles went up and down and asked: where is god. other option is that god launched itself to heaven/earth and a rebellion angle minimized him and weaken him significantly also by using quantum mechanics and inspiration zones.

Maybe by this invention of mine I return the leadership of arich anpin, when there is any products to any one that's by the ability of this invention to duplicate any thing, food, gold, cars etc. and there is no poverty.

Maybe be using neutrino it is possible to pass to other scenarios/dimensions by using their ability to pass true any thing for my conclusion.

Also thoughts pass at inspiration zones and earphones and microphones increase the influence.

Maybe it is possible to pass location of micro universe by clicking on wanted point on computerized map, navigation map also people, objects etc.

*the shape of launching and/or duplicating/multiplying people/objects to other time, past/future other scenario/dimension should be a circle more than square for my assumption also of circle shape cab/cell in order to avoid twists and in order to spread the powers, magnetic/electromagnetic/t.v. waves, frequencies at shape of luminum, circled beam/radio waves, frequencies at shape of luminum/circled beam and others equally. See also my invention number: 266246.il.2019.4 5

1. using a cellular mobile phones net and antennas and transmitters that broadcast electromagnetic signals all time all over the planet and beyond and concentrating and/or using microphone connected to mobile telephone net, planted at mouth and naming a place and time, past present or future at a place and time for example same point at this address, 30 days ago and possible thinking about the place of earth at past or future time around the sun and aiming to get to other point or same point at other time and/or scenario, dimension and getting tracked at the wanted point and time and place including scenario/dimension.

2. using time machines from this invention claim 1 and/or my invention number 266246.il.2019. in order to send alert to woman or men who discovered cancer at their body at breast or other organ and/or leukemia and enabling them to getting checked mounts or years earlier and by that getting saved by discovering the tumor or illness of an kind sooner before it gets worse. All claims can be beyond time/scenario/dimension and combined.
Using quantum mechanics and inspiration zones and model, mechanic one or at software in order to watch and copy all data, information from a small scale earth in order to make it easier to monitor all passing and existing information on earth and or beyond from a micro earth with short rang watching on a duplicate from last hour, minute or as real time from a model connected.

3. using electromagnetic signal from present and sending it with using transmitters and antennas to the open air and using an unwired fax/printer that will get the right frequency and translate it to fax massage or email massage at smartphone also as phone call, tablet, mobile computer or computer with antenna that can receive the transmission at past and present and future by locking on the frequency that match and using frequencies match and equalization and the electromagnetic/t.v. waves/radio waves/magnetic signal will be tracked, sucked to the right place and time and scenario, dimension etc. also text massages of any kind exist or that will be in use at future or was at use at past.
All claims can be beyond time/scenario/dimension and combined.

4. using quantum mechanics and inspiration zones and model at software and/or mechanic type model in order to clean reshimo/impression/memory left, of un wanted events to the operator by using electromagnetic barcode that would be adjusted to the area were the un wanted event happened and would have the certain frequency of the event and the sub particles and particles would be gathered usefully by operating the right electromagnetic frequency that can truck the sub particles and particles that build the un wanted reshimo and it is my assumption that a difficult reshimo to get read of is one that its sub particles and particles are with certain magnetic/electromagnetic caricature that do not spread and disappeared easily and need a device with method I wrote here in order to track them and clean the model and by that the real place and time from their presents and also by transmitting the frequency of the place where the event happened from close time but before the event in order to clean the reshimo and strengthen the reshimo of an place without traumatic event also by connecting 10, 100 or more clean time from un wanted event from same point, place.
also by using magnetic track on of the sub particles and particles that build the un wanted reshimo and also give the sub particles and particles that has no magnetic caricature such magnetic caricature by marking them with magnetic paint of some kind or by using other method and cleaning the un wanted sub particles and particles from the right place and time by using manipulation on the model/s and by that influence on the real world and place and time and make an event disappear, also it is possible to use t.v./radio waves that and or electric field that will get to the un wanted particle and sub particles and mark them in order to cause a transmission of them to an antenna outside the place and time were the un wanted event happed and by that make the event and particles sub particles disappear and by using a condenser, capacitor in order to gather particles and sub particles that has electric charge and charging the particles and sub particles that build the reshimo and gathering them with using condenser capacitor. All claims can be beyond time/scenario/dimension and combined.

5. using quantum mechanics and inspiration zones in order to create servers room, big enough to serve the all state and/or world by minimizing the room with servers at 1:1000, 1:100000, etc. the servers will by multiply by 10, 100, 1000, 100000 etc., by quantum mechanics and inspiration zones right next to the other. All claims can be beyond time /scenario/dimension and combined.

6. using quantum mechanics and inspiration in order to multiply warehouses with important equipment as conserved food, food, bottled water, cans of oil, crude oil, petrol, fuel, medical equipment and minimize the ware houses with equipment with them in order to save place and have a lot more equipment at emergency and all time, when needed launching the supply or streaming it at real size or bigger than 1:1 or 2:1, 3:1, 1000:1, 1000000:1, 1 billion:1 etc. All claims can be beyond time/scenario/dimension and combined.

7. using micro territories, hidden territories in order to build a lot more than it is possible at a small country facilities with magnets for using as quantum mechanics and creating inspiration zones and also multiplying the magnets again and again as much needed and spreading on the wide created area by quantum mechanics and inspiration zones based on first magnetic inspiration and by that lift the power of a country to be as great country and trying to pass that powers to the main scenario as needed and also gathering as much as it can be done scenarios in order to have at total a lot more power also electromagnetic/t.v. waves/radio waves/electric fields gathered together to great total power and creating artificial scenarios and dimension and arranging them at a shape of accordion at the model,
at software at computer and/or mechanics and/or at a shape of apiary, beehive arrangement of scenarios and dimensions that were multiplying with using quantum mechanics and inspiration zones by using magnetic/electromagnetic/t.v. waves/radio waves/electric fields in order to do so and also by that having a very strong and long range time machines including scenarios/dimension machines and combined. Also beyond time and scenarios/dimensions.

8. Using the way gravity waves move in order to create time loops by making them longer like parabola hyperbola and banding time and it can be us full in order to correct, fix critical mistakes prepper to disasters and earn spear time to get ready to thing, events it will be done by other magnets that will band the waves coming from other place, source, magnets also can be in use electromagnetic waves,
power electric field and t.v. and or radio waves and it can create loops at future and/or past,
present and a person can be at past, present future at parallel. All claims can be beyond time/scenario/dimension and combined.

9. Using fly made materials in order to collect, gather energy efficiently at day into batteries/chargers by using panels that absorbs energy from sun light at day time for the use of robots, cyborgs vehicles equipment also for smartphones, tablets, mobile computers, mobile phones, radio equipment other equipment that need batteries in order to work at filed or home etc. and on top of fly made materials cover natural synthetic in can be use a fabric cover for hygienic and good feeling, those panels of fly made material are very use full also for homes, apartments, buildings, cities, states in order to supply energy to the people/industry/offices/streets over there also it is possible to add zinc glycogen,
glucose, Helmond in order to increase/improve efficiency of fly made materials panels. All claims can be beyond time/scenario/dimension and combined.

10. Using quantum mechanics and inspiration zones and different frequencies in order to create different time zones in order to block un wanted visitors at a place by traveling from same point from different times and by hiding the exact frequencies needed to pass and or using transmitters that interrupt and block/prevent broadcasting the needed frequency at all time and or certain times also it possible to use a model mechanics or at software and transmit at the different models for every period of time a different frequency.

11. using quantum mechanics and inspiration zones and model, mechanics or at software and bar codes and/or electromagnetic transmitters that will marl people and or objects including great ones like states,
planets, moons or more and based on marking the people and/or objects that are marked will be launch to other point and other time, scenario/dimension by tracking the bar codes and transmitters and diluting the objects and/or people and pulling, sucking them by using magnetic/electromagnetic/electric field/t.v. waves/radio waves into other point, place, other time, other scenario/dimension, universe even and crystalizing the people objects by increasing the magnetic/electro magnetic other powers, allow or combines, any possible combination and thickening the people objects to 100% from 0% after diluting them before and 100% step before that by improving the locking on people and/or objects based on barcodes and electromagnetic transmitters and/or magnetic signature or electric filed signature or frequency of t.v waves/radio waves, very accurate.

12. Using transmitter/receiver with definition to get signals from long distance only, more than 70 -100 kilometers in order to get location accurately from a satellite at the outside skies and atmosphere and not from internal layer of hidden territory that the person checking is in it.

13. Using quantum mechanics and inspiration zones and model, mechanics and/or at software and building a model of railways that will fit to the distance between one city and other city or and placing the model of railways on top of the general model of the state, than increasing correlation, inspiration and the railways will appear at the real world, state after transmitting the electromagnetic/magnetic signals to the air or by other methods as electric field and t.v. waves/radio waves and transmitting to the open air and/or using inspiration zones by inspiring the model on the real world/state by those methods of transmitting and inspiring and also possible to use segments and other infrastructures, buildings etc. also beyond time and scenario/dimension, universe for example the train and railways can be ready 20 years ago.

14. Using light in order to increase the power of magnets, magnetic influence by aiming the rays of light to the same direction together with the magnets and there and at this direction the magnetic influence will be greater than dark direction and it can be used in order to expand the range of the time machines in this invention and my invention number 266246.il.2019. by strengthening the power of magnets that create the inspiration zones also using xenon light in order to increase power even more. also discovery at astronomy: the moon influence by its gravity on seas on earth at the middle of Hebrew months when it is fool moon because at that time the moon in Enlighted at maximum in front of other times at month when it is part lighted or not at all at the end of Hebrew months.

15. Using quantum mechanics and inspiration zones and the model possible in order to duplicate an small earth or other planets, moons, suns in order to investigate layers more easily by using stick with sharp edge and hollow inside and taking samples and explore from and at very deep layers when the small astronomical bodies can be 1 meter at diameter. also beyond time and/or scenario/dimension by using magnetic/electro magnetic/electric field/t.v. waves/radio waves in order to create inspiration zones and aiming the physical power at right frequencies towards the astronomical bodies and an advanced prepared files, ware house in order to hold the minimized astronomical bodies, also by using a model, mechanic one and also using pneumatic pipe that will connect the earth and the asteroid and sucking, pulling the astronomical body to the model on face of earth, model earth from a second model next to earths model also it can be a way to launch people and equipment from one planet to the other 14 including moons, galaxies, universes also the exact magnetic/electromagnetic signature as smartphone personal number will return the person/equipment exactly and launch him/her/it exactly on spot.
Using quantum mechanics and inspiration zones including moons, galaxies, universes also the exact magnetic/electromagnetic signature as smartphone personal number will return the person/equipment exactly and launch him/her/it exactly on spot.

16. Using quantum mechanics and inspiration zones in order to duplicate asteroids that contain expensive metal and rare material at small scale in order to use the rare materials any kind of use and the size can be 0.0001-100 meters for example. also beyond time, scenario/dimension by using magnetic/electro magnetic/electric field/t.v. waves/radio waves in order to create inspiration zones and aiming the physical power at right frequencies towards the astronomical bodies and an advanced prepared fields, ware house in order to hold the minimized astronomical bodies also by using a model, mechanic one and also using pneumatic pipe that will connect the earth and the asteroid and sucking, pulling the astronomical body to the model on face of earth, model earth from a second model next to earths model also it can be a way to launch people and equipment from one planet to the other including moons, galaxies, universes. and also beyond time and scenario/dimensions.
